(19) United States
(12) Patent Application Publication
(10) Pub. No.: US 2012/0113323 A1
(43) Pub. Date: May 10, 2012

(54) COMPARING LOW QUALITY BROADCASTS TO HIGH QUALITY BRAODCASTS

(75) Inventors: Kulvir S. Bhogal, Pflugerville, TX (US); Gregory J. Boss, Saginaw, MI (US); Rick A. Hamilton, II, Charlottesville, VA (US); Andrew R. Jones, Round Rock, TX (US); Brian M. O'Connell, RTP, NC (US)

(73) Assignee: INTERNATIONAL BUSINESS MACHINES CORPORATION, Armonk, NY (US)

(21) Appl. No.: 12/939,475

(22) Filed: Nov. 4, 2010

(51) Int. Cl. H04N 5/46

(52) U.S. Cl. 348/555; 348/E05.114

(57) ABSTRACT

A system, method, and computer program product for comparing a low quality broadcast to a high quality broadcast on a display device to show users the benefits of a high quality broadcast over a low quality broadcast. The display device capabilities are detected and compared to retrieved requirements for displaying a high quality broadcast. If the display requirements are met, retrieving the high quality broadcast and displaying the low quality and high quality broadcasts on a display device for user comparison. Then, the user accepts either the high quality or low quality broadcast and displays the high quality broadcast or the low quality broadcast in accordance with the user selection.

### BACKGROUND

The present invention relates to providing a user with a comparison of a low quality broadcast to a high quality broadcast, and more specifically to providing a user with a comparison of a low quality broadcast to a high quality broadcast to discern the disparate qualities of the high quality broadcast over the low quality broadcast.

Air television broadcasts are moving to an all high-definition (HD) format, and cable and satellite maintain a dual system of channels that includes standard-definition (SD) and high-definition (HD) formats. In many cases, the usage of the high-definition formats is an additional charge for users and provisioned on a subscriber by subscriber basis.

Most user's have televisions that are capable of displaying high-definition formatted broadcasts and programs, however, not all users are aware of the advantages of viewing a high-definition broadcast over a standard definition broadcast.

### BRIEF SUMMARY

According to one embodiment of the present invention, a method of displaying a comparison of a high quality broadcast to a low quality broadcast on a display device and a computer coupled to a service provider. The method includes the computer detecting one or more display capabilities of the display device. The computer retrieves from the service provider one or more requirements for displaying the high quality broadcast on the display device from the service provider. The computer determines that the display capabilities of the display device meet the requirements for displaying the high quality broadcast. The computer in response to determining whether the display capabilities of the display device meet the requirements for displaying the high quality broadcast, retrieves the high quality broadcast for comparison to the low quality broadcast and directs the display device to display low quality broadcast and the high quality broadcast on the display device so that a user may select between the low quality broadcast and the high quality broadcast. The computer in response to the user selection directs the display device to display the high quality broadcast or the low quality broadcast.

According to another embodiment of the present invention, a computer program product for displaying a comparison of a high quality broadcast to a low quality broadcast on a display device coupled to a computer and a service provider. The computer program product comprises one or more computer-readable, tangible storage devices and program instructions stored on at least one of the one or more storage devices. The program instructions include detecting one or more display capabilities of the display device; retrieving one or more requirements for displaying the high quality broadcast on the display device from the service provider; and determining that the display capabilities of the display device meet the requirements for displaying the high quality broadcast. In response to determining whether the display capabilities of the display device meet the requirements for displaying the high quality broadcast, program instructions to retrieve the high quality broadcast for comparison to the low quality broadcast and to direct the display device to display low quality broadcast and the high quality broadcast on the display device so that a user may select between the low quality broadcast and the high quality broadcast. In response to the user selecting the high quality broadcast, direct the display device to display the high quality broadcast and program instructions to in response to the user selecting the low quality broadcast, directing the display device to display the low quality broadcast.

According to another embodiment of the present invention, a computer system for displaying a comparison of a high quality broadcast to a low quality broadcast on a display device coupled to a computer and a service provider. The computer system includes one or more processors, one or more computer-readable memories and one or more computer-readable, tangible storage devices; and program instructions stored on at least one of the one or more storage devices for execution by at least one of the one or more processors via at least one of the one or more memories. The program instructions include detecting one or more display capabilities of the display device; retrieving one or more requirements for displaying the high quality broadcast on the display device from the service provider; and determining whether the display capabilities of the display device meet the requirements for displaying the high quality broadcast.

The program instructions stored on at least one of the one or more storage devices for execution by at least one of the one or more processors via at least one of the one or more memories, to in response to determining that the display capabilities of the display device meet the requirements for displaying the high quality broadcast, program instructions to retrieve the high quality broadcast for comparison to the low quality broadcast and to direct the display device to display low quality broadcast and the high quality broadcast on the display device so that a user may select between the low quality broadcast and the high quality broadcast. In response to the user selecting the high quality broadcast, direct the computer to display the high quality broadcast and program instructions to in response to the user selecting the low quality broadcast, directing the computer to display the low quality broadcast.

### BRIEF DESCRIPTION OF THE SEVERAL VIEWS OF THE DRAWINGS

FIG. 1 is a computer network in which illustrative embodiments may be implemented.

FIG. 2 is a data processing system in which illustrative embodiments may be implemented.

FIG. 3 shows a block diagram of a digital video recorder (DVR) in which illustrative embodiments may be implemented.

FIG. 4 shows a flow chart of a method for displaying a comparison of a high quality broadcast to a low quality broadcast on a display, enabling a user to discern the disparate quality of the high quality broadcast over the low quality broadcast, in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

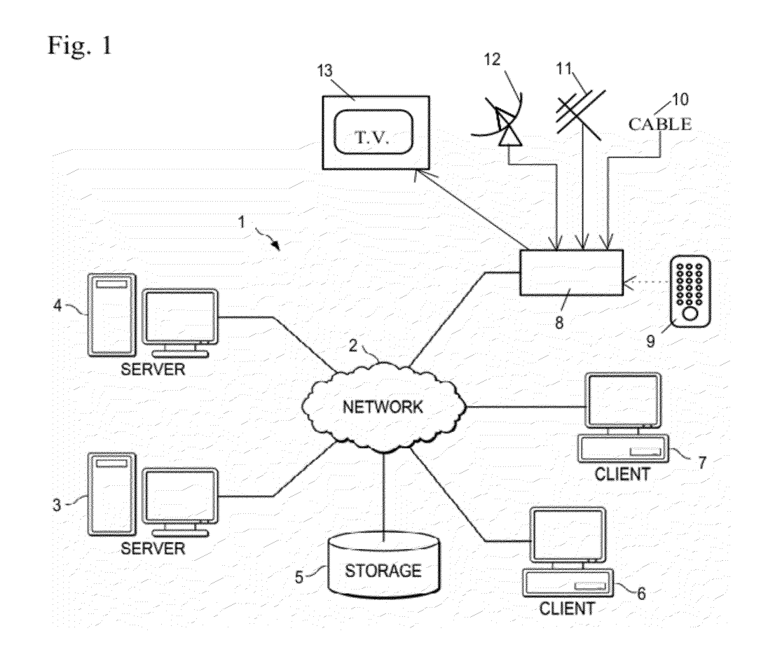

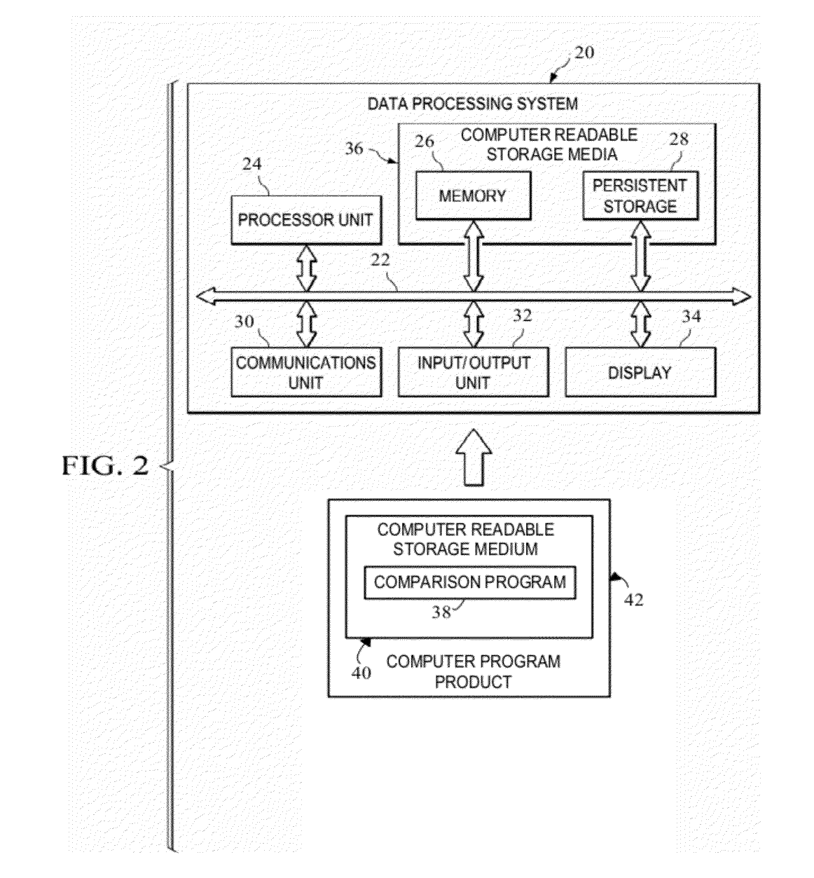

With reference now to the figures, and in particular, with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 1 is a network of computers in which illustrative embodiments may be implemented. Network data processing system 1 contains network 2, which is the medium used to provide communication links between various devices and computers connected together within network data processing system 1. Network 2 may include connections, such as wire, wireless communication links, or fiber optic cables.

In the depicted example, server 3 and server 4 connect to network 2 along with storage unit 5. In addition, clients 6 and 7 and digital video recorder (DVR) 8 connect to network 2. Clients 6 and 7 may be, for example, personal computers, network computers, or other portable devices. DVR 8 may be connected to cable 10, a television antenna 11, and/or satellite 12 to receive a signal from a broadcasting network that is displayed on a television (T.V.), monitor, or other display device 13 connected to the DVR 8. Universal remote 9 may be used to interact with the DVR 8. Clients 6 and 7 may also be used to interact with the DVR 8. In the depicted example, server 3 provides information, such as boot files, operating system images, and applications to clients 6 and 7, and DVR 8. Clients 6 and 7, and DVR 8 are clients to server 3 in this example. Network data processing system 1 may include additional servers, clients, and other devices not shown.

Program code or television broadcasts located in network data processing system 1 may be stored on a computer readable storage medium and downloaded to a data processing system or other device for use. For example, program code may be stored on a computer readable storage medium on server 4 and downloaded to client 8 over network 2 for use on client 8.

In the depicted example, network data processing system 1 is the Internet with network 2 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 1 also may be implemented as a number of different types of networks, such as, for example, an intranet, local area network (LAN), or a wide area network (WAN). FIG. 1 is intended as an example, and not as an architectural limitation, for the different illustrative embodiments.

With reference now to FIG. 2, a block diagram of a data processing system is shown in which illustrative embodiments may be implemented. Data processing system 20 is an example of a DVR, such as DVR 8 in FIG. 1, in which computer readable program code or instructions may be located for the illustrative embodiments. Data processing system 20 can include communications fabric 22, processor unit 24, memory 26, persistent storage 28, communications unit 30, input/output (I/O) unit 32, and display 34. In this illustrative example, communications fabric 22 can provide communications between processor unit 24, memory 26, persistent storage 28, communications unit 30, input/output (I/O) unit 32, and display 34.

Processor unit 24 serves to execute instructions for software that may be loaded into memory 26. Processor unit 24 may be a set of one or more processors, or may be a multi-processor core, depending on the particular implementation. Further, processor unit 24 may be implemented using one or more heterogeneous processor systems in which a main processor is present with secondary processors on a single chip. As another illustrative example, processor unit 24 may be a symmetric multi-processor system containing multiple processors of the same type.

Memory 26 and persistent storage 28 are examples of computer readable storage media 36. Memory 26, in these examples, may be, for example, a random access memory or any other suitable volatile or non-volatile computer readable storage medium. Persistent storage 28 may take various forms depending on the particular implementation. For example, persistent storage 28 may contain one or more components or devices. For example, persistent storage 28 may be a hard drive, a flash memory, a rewritable optical disk, a rewritable magnetic tape, or some combination of the above. The media used by persistent storage 28 also may be removable. For example, a removable hard drive may be used for persistent storage 28.

Communications unit 30, in these examples, provides for communications with other data processing systems or devices. In these examples, communications unit 30 is a network interface card. Communications unit 30 may provide communications through the use of either or both physical and wireless communication links.

Input/output unit 32 allows for input and output of data with other devices that may be connected to data processing system 20. For example, input/output unit 32 may provide a connection for user input through a keyboard, a mouse, and/or some other suitable input device. Further, input/output unit 32 may send output to a printer. Display 34 provides a mechanism to display information to a user.

Instructions for an operating system, applications, and/or programs may be located in computer readable storage media 36, which are in communication with processor unit 24 through communications fabric 22. In these illustrative examples the instructions are in a functional form on persistent storage 28. These instructions may be loaded into memory 26 for running by processor unit 24. The processes of the different embodiments may be performed by processor unit 24 using computer implemented instructions, which may be located in a memory, such as memory 26.

These instructions are referred to as program code, computer usable program instructions, or computer readable program instructions, that may be read and run by processor unit 24. The program code in the different embodiments may be embodied on different physical or tangible computer readable storage media, such as memory 26 or persistent storage 28.

Comparison program 38 is located in a functional form on computer readable storage medium 40 that is selectively removable and may be loaded onto or transferred to data processing system 20 for running by processor unit 24. Comparison program 38 and computer readable storage medium 40 form computer program product 42 in these examples. In some instances, computer readable storage medium 40 may not be removable.

Alternatively, comparison program 38 may be transferred to data processing system 20 from computer readable storage medium 40 through a communications link to communications unit 30 and/or through a connection to input/output unit 32. The communications link and/or the connection may be physical or wireless in the illustrative examples.

In some illustrative embodiments, comparison program 38 may be downloaded over a network to persistent storage 28 from another device or data processing system for use within data processing system 20. For instance, program code stored in a computer readable storage medium in a server data processing system may be downloaded over a network from the server to data processing system 20. The data processing system providing comparison program 38 may be a server computer, a client computer, or some other device capable of storing and transmitting comparison program 38.

The different components illustrated for data processing system 20 are not meant to provide architectural limitations to the manner in which different embodiments may be implemented. The different illustrative embodiments may be implemented in a data processing system including components in addition to, or in place of, those illustrated for data processing system 20. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a bus system may be used to implement communications fabric 22 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 26 or a cache such as found in an interface and memory controller hub that may be present in communications fabric 22.

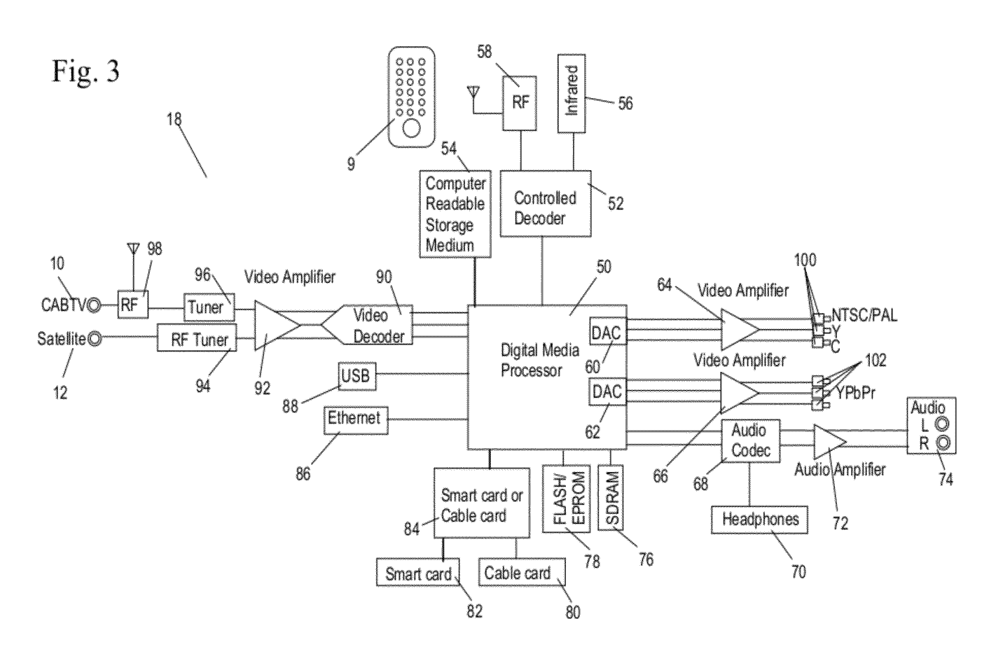

FIG. 3 shows an exemplary diagram of a video recorder, in particular a DVR 18, in which illustrative embodiments may be implemented. DVR 18 is another example of DVR 8 shown in FIG. 1. It should be appreciated that FIG. 3 is only exemplary and are not intended to assert or imply any limitation with regard to different embodiments which may be implemented. Modifications to the DVR 18 may be made.

DVR 18 includes digital media processor 50 with at least one digital-to-analog converter 60 which is connected to a video amplifier 64 and has inputs 100 for National Television System Committee (NTSC)/phase alternate line (PAL), and composite video Y and C. A second digital-to-analog converter 62 is preferably present in the digital media processor 50 and is connected to a video amplifier 66 and has inputs 102 for YPbPr or component video.

Digital media processor 50 is also connected to an audio codec 68 for encoding analog audio into digital signals and decoding digital signals into analog signals. Audio codec 68 is connected to headphones 70 and audio amplifier 72 for audio left L and right R outputs 74.

DVR 18 also has computer readable storage medium 54 as well as flash or erasable programmable read only memory (EPROM) 78 and synchronous dynamic random access memory (SDRAM) 76 enabling a user to store TV broadcasts of their choosing.

Input 84 for smart card 82 or cable card 80 may be present with the DVR 8 for users who need to decode an encrypted digital cable signal without using a set-top box.

DVR 18 has at least one tuner 96, and preferably has at least two tuners 94, 96. Tuner 96 is connected to receive an input for cable television 10 or to receive a broadcast signal through a radio frequency (RF) antenna 98. Tuner 96 is connected to video amplifier 92, which in turn is connected to video decoder 90 that sends a signal to digital media processor 50. Second tuner 94 is connected to an input 12 for satellite and to video amplifier 92. From video amplifier 92, a signal goes through video decoder 90 to digital media processor 50. Digital media processor 50 also has a port to connect to Ethernet 86 or to another device through a universal serial bus (USB) port 88.

Universal remote 9 can control digital media processor 50 of DVR 18. Universal remote 9 communicates with controlled decoder 52, which is coupled to digital media processor 50 through infrared 56 or radio frequency (RF) signals 58.

Illustrative embodiments of the invention include a method, a system, and a computer program product for presenting a user subscribing to or receiving service from a service provider with a comparison of a low quality broadcast to a high quality broadcast display. The comparison advantageously allows the user to discern one or more differences between the low quality broadcast and the high quality broadcast on display. The differences may include picture quality, audio quality, and any other distinguishing qualities of a broadcast. The comparison may also advantageously lead to the user's purchase of high quality broadcast services from the service providers. The service provider may be, but is not limited to a cable company, a satellite company, an Internet rental service, an Internet viewing service, or a DVR company.

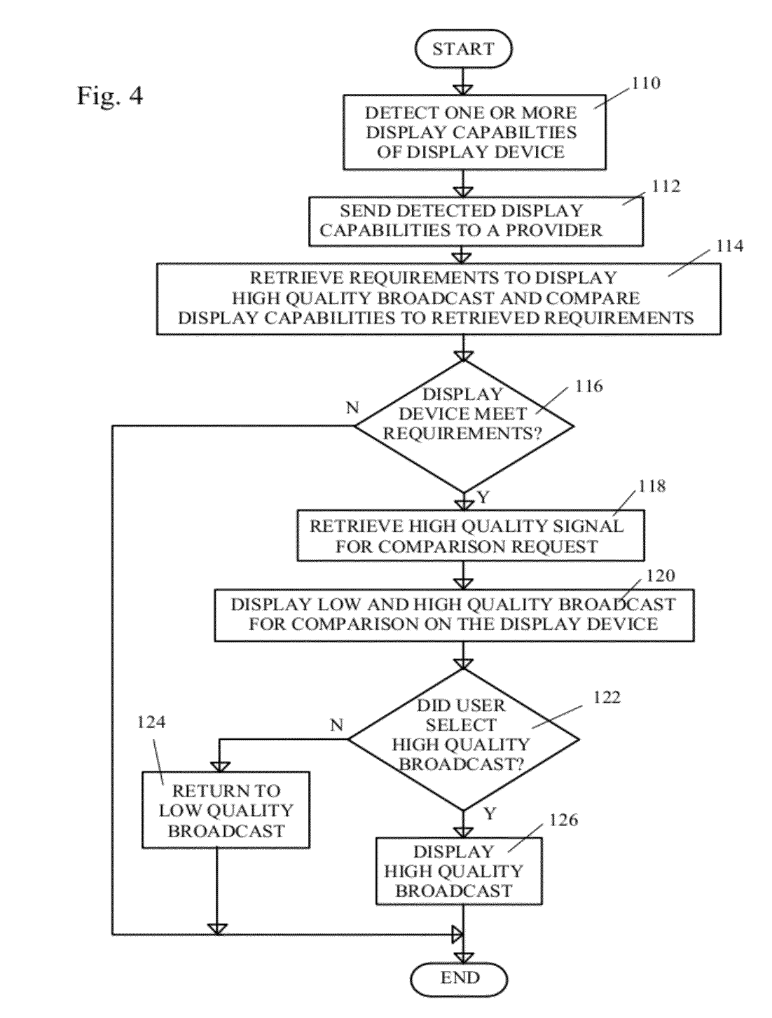

FIG. 4 shows a flowchart of a method for displaying a comparison of a high quality broadcast to a low quality broadcast on a display device in accordance with an illustrative embodiment. It will be understood that each block or combination of blocks shown in FIG. 4 can be implemented by computer program instructions of comparison program 38, which can be stored on a computer readable storage medium, e.g. computer readable storage medium 40 or computer readable storage medium 54, and can be executed by a central processing unit, e.g. processor unit 24 or digital media processor 50.

At block 110, in response to comparison request between the low quality broadcast and the high quality broadcast, comparison program 38 detects one or more display capabilities of the display device, e.g., television, monitor, or display device 13 or display 34. The display can be coupled to a service provider directly or through a DVR, e.g., DVR 8, DVR 18, or data processing system 20. The comparison request can be initiated through an advertisement displayed during a particular broadcast, on the display device through a channel accessible on the display device and specifically provisioned for this purpose by a service provider, or through other means. For example, an advertisement overlay may be broadcasted with a low quality broadcast stream that solicits a user to view the high quality broadcast by pressing a button on a remote control, e.g. universal remote 9. In other embodiments, the comparison request may also be automatically initiated in response to a lack of activity on the display device or for particular programs shown on the display device.

In one embodiment, comparison program 38 can detect the display capabilities in response to the user manually configuring the display capabilities within the DVR. For example, the user may utilize the DVR to select from a set of resolutions supported by the display device. In another embodiment, the user may store a make and model of the display device in the DVR. In one example, the make and model can be stored in a database accessible to the DVR. The database may be internal to the DVR or external to DVR, e.g. on storage unit 5.

Alternatively, comparison program 38 can detect the display capabilities by determining a connection type used to couple the DVR to the display device. For example, certain connection types have inherent limitations, such as composite or S-video, and these connection types may be not be capable of displaying high quality broadcasts.

Additionally comparison program 38 can detect the display capabilities using an in-band or out-of-band communication device. An in-band communication may be carried out via a 2-way communication protocol using a display connection between the DVR and the display device. An out-of-band communication may take place using, an in-band or out-of-band form of communication. An in-band form of communication may be carried out via a 2-way communication protocol using, e.g. Ethernet, USB, wireless Ethernet, or Bluetooth.

At block 112, comparison program 38 sends the display capabilities to the service provider. At block 114, comparison program 38 retrieves one or more display requirements for displaying the high quality broadcast from the service provider. The service provider can retrieve the display requirements from a database. At block 116, comparison program 38 compares the display capabilities to the display requirements to determine whether the display capabilities meet the display requirements. If at block 116, comparison program 38 determines that the display capabilities do not meet the display requirements, the method ends.

In response to determining that the display capabilities meet the display requirements, at block 118, comparison program 38 retrieves the high quality broadcast. In one embodiment, comparison program, 38 retrieves the high quality broadcast from the service provider and may apply the high quality broadcast to a current channel being viewed by the user or to a different channel.

Alternatively, the DVR may retrieve the high quality broadcast over a network, e.g. network 2, using known authorization and transmission methodologies. The high quality broadcast may be stored by and may be accessible from a creator of the high quality broadcast, the service provider, or a DVR service provider. Additionally the high quality broadcast may be stored locally in memory on the DVR.

At block 120, comparison program 38 causes the DVR to display the low quality broadcast and the high quality broadcast on the display device for the user to make a comparison. In one embodiment, the display device is coupled to the DVR, and the DVR has at least one tuner, e.g. tuner 96. The DVR displays the high quality broadcast from the service provider for a defined period of time or number of frames and then displays the low quality broadcast for a defined period of time or number of frames for a defined number of iterations. Comparison program 38 may direct the DVR to overlay text on the low quality broadcast and/or the high quality display indicating the quality of the respective broadcast being shown.

In another embodiment, the display device is coupled to a DVR, and the DVR has at least two tuners, e.g., tuners 94, 96 with one tuner tuned to the low quality broadcast signal and the other tuner tuned to the high quality broadcast signal. The DVR may display both the low quality broadcast or image and the high quality broadcast or image simultaneously using a split screen or other picture in picture (PiP) format, such as, but not limited to progressive screen wipe, one full screen one inset, a moving split screen that cycles between a full screen low quality broadcast display and a small high quality broadcast display to a full screen high quality broadcast display and a small low quality broadcast display. Comparison program 38 may direct the DVR to overlay text on the low quality broadcast and/or the high quality display indicating the quality of the respective broadcast being shown.

Alternatively, a single channel of the service provider may designated to display both the low quality broadcast and the high quality broadcast. The comparison of the low quality broadcast to the high quality broadcast may be displayed using, but not limited to picture in picture (PiP), transitions from one broadcast to the other, and still frame comparisons.

At block 122, comparison program 38 determines whether the user has chosen the high quality broadcast. In response to determining that the user has chosen the high quality broadcast, at block 126, comparison program 38 directs the DVR to display the high quality broadcast on the display device and the method ends.

In response to determining that the user has not chosen the high quality broadcast, at block 124, comparison program 38 directs the DVR to return to the low quality broadcast and the method ends.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of displaying a comparison of a high quality broadcast to a low quality broadcast on a display device coupled to a computer and a service provider comprising the steps of:
the computer detecting one or more display capabilities of the display device;
the computer retrieving from the service provider one or more requirements for displaying the high quality broadcast on the display device;
the computer determining whether the display capabilities of the display device meet the requirements for displaying the high quality broadcast;
the computer in response to determining that the display capabilities of the display device meet the requirements for displaying the high quality broadcast:
retrieving the high quality broadcast for comparison to the low quality broadcast; and
directing the display device to display the low quality broadcast and the high quality broadcast on the display device so that a user may select between the low quality broadcast and the high quality broadcast;
the computer directing the display device to display the high quality broadcast or the low quality broadcast in response to the user selection.

2. The method of claim 1, wherein the computer is a digital video recorder.

3. The method of claim 1, wherein the computer detecting one or more display capabilities of the display device comprises accepting one or more manually entered capabilities by the user.

4. The method of claim 1, wherein the computer detecting one or more display capabilities of the display device comprises determining a connection type for coupling the display device to the computer.

5. The method of claim 1, wherein the computer detecting one or more display capabilities of the display device comprises determining the capabilities of the computer with an in-band or out-of-band communication device.

6. The method of claim 1, wherein the computer directing the display device to display the low quality broadcast and the high quality broadcast on the display device so that the user may select between the low quality broadcast and the high quality broadcast comprises directing the computer to display the low quality broadcast and the high quality broadcast on the display device simultaneously.

7. The method of claim 1, wherein the computer directing the display device to display the low quality broadcast and the high quality broadcast on the display device so that the user, may select between the low quality and the high quality broadcast comprises directing the computer to display the low quality broadcast and the high quality broadcast on the display device sequentially.

8. A computer program product comprising one or more computer readable, tangible storage devices and computer-readable program instructions which are stored on the one or more storage devices and when executed by one or more processors, perform the method of claim 1.

9. A computer system comprising one or more processors, one or more computer readable memories, one or more computer-readable, tangible storage devices and program instructions which are stored on the one or more storage devices for execution by the one or more processors via the one or more memories and when executed by the one or more processors perform the method of claim 1.

10. A computer program product for displaying a comparison of a high quality broadcast to a low quality broadcast on a display device coupled to a computer and a service provider, the computer program product comprising:
one or more computer-readable, tangible storage devices;
program instructions, stored on at least one of the one or more storage devices, to detect one or more display capabilities of the display device;
program instructions, stored on at least one of the one or more storage devices, to retrieve one or more requirements for displaying the high quality broadcast on the display device from the service provider;
program instructions, stored on at least one of the one or more storage devices, to determine that the display capabilities of the display device meet the requirements for displaying the high quality broadcast;
program instructions, stored on at least one of the one or more storage devices, to in response to determining whether the display capabilities of the display device meet the requirements for displaying the high quality broadcast:
retrieve the high quality broadcast for comparison to the low quality broadcast; and
direct the display device to display the low quality broadcast and the high quality broadcast on the display device so that a user may select between the low quality broadcast and the high quality broadcast;
program instructions, stored on at least one of the one or more storage devices, to in response to the user selecting the high quality broadcast, direct the display device to display the high quality broadcast; and
program instructions, stored on at least one of the one or more storage devices, to in response to the user selecting the low quality broadcast, directing the display device to display the low quality broadcast.

11. The computer program product of claim 10, wherein the program instructions to detect one or more display capabilities of the display device accept one or more manually entered capabilities by the user.

12. The computer program product of claim 10, wherein the program instructions to detect one or more display capabilities of the display device determine a connection type for coupling the display device to the computer.

13. The computer program product of claim 10, wherein the program instructions to detect one or more display capabilities of the display device determine the capabilities of the computer with an in-band or out-of-band communication device.

14. The computer program product of claim 10, wherein the program instructions to direct the display device to display the low quality broadcast and the high quality broadcast on the display device so that the user may select between the low quality broadcast and the high quality broadcast direct the computer to display the low quality broadcast and the high quality broadcast on the display device simultaneously.

15. The computer program product of claim 10, wherein program instructions to direct the display device to display the low quality broadcast and the high quality broadcast on the display device so that the user, may select between the low quality and the high quality broadcast direct the computer to display the low quality broadcast and the high quality broadcast on the display device sequentially.

16. A computer system for displaying a comparison of a high quality broadcast to a low quality broadcast on a display device coupled to a computer and a service provider, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to detect one or more display capabilities of the display device;
program instructions, stored on at least one of the one or more storage devices for execution by at least one of the one or more processors via at least one of the one or more memories, to retrieve one or more requirements for displaying the high quality broadcast on the display device from the service provider;
program instructions, stored on at least one of the one or more storage devices for execution by at least one of the one or more processors via at least one of the one or more memories, to determine whether the display capabilities of the display device meet the requirements for displaying the high quality broadcast;
program instructions, stored on at least one of the one or more storage devices for execution by at least one of the one or more processors via at least one of the one or more memories, to in response to determining that the display capabilities of the display device meet the requirements for displaying the high quality broadcast:
retrieve the high quality broadcast for comparison to the low quality broadcast; and
direct the display device to display low quality broadcast and the high quality broadcast on the display device so that a user may select between the low quality broadcast and the high quality broadcast;
program instructions, stored on at least one of the one or more storage devices for execution by at least one of the one or more processors via at least one of the one or more memories, to in response to the user selecting the high quality broadcast, direct the display device to display the high quality broadcast; and
program instructions, stored on at least one of the one or more storage devices for execution by at least one of the one or more processors via at least one of the one or more memories, to in response to the user selecting the low quality broadcast, directing the display device to display the low quality broadcast.

17. The computer system of claim 16, wherein the program instructions to detect one or more display capabilities of the display device accept one or more manually entered capabilities by the user.

18. The computer system of claim 16, wherein the program instructions to detect one or more display capabilities of the display device determine a connection type for coupling the display device to a computer.

19. The computer system of claim 16, wherein the program instructions to detect one or more display capabilities of the display device determining the capabilities of the computer with an in-band or out-of-band communication device.

20. The computer system of claim 16, wherein the program instructions to direct the display device to display the low quality broadcast and the high quality broadcast on the display device so that the user may select between the low quality broadcast and the high quality broadcast direct the computer to display the low quality broadcast and the high quality broadcast on the display device simultaneously.

21. The computer system of claim 16, wherein program instructions to direct the display device to display the low quality broadcast and the high quality broadcast on the display device so that the user, may select between the low quality and the high quality broadcast direct the computer to display the low quality broadcast and the high quality broadcast on the display device sequentially.
